(19) United States
(12) Patent Application Publication
(10) Pub. No.: US 2025/0105689 A1
(43) Pub. Date: Mar. 27, 2025

(54) ARRANGEMENT FOR COOLING A ROTOR OF AN ELECTRIC MACHINE

(71) Applicant: ZF Friedrichshafen AG, Friedrichshafen (DE)

(72) Inventors: Moritz Stenger, Friedrichshafen (DE); Marcel Müller, Koeln (DE); Mario Gudlin, Aldenhoven (DE)

(73) Assignee: ZF Friedrichshafen AG, Friedrichshafen (DE)

(21) Appl. No.: 18/730,056

(22) PCT Filed: Jan. 16, 2023
(86) PCT No.: PCT/EP2023/050848

§ 371 Date: Jul. 18, 2024

(30) Foreign Application Priority Data
Jan. 18, 2022 (DE) 10 2022 200 509.0

(51) Int. Cl. H02K 1/32; H02K 5/20; H02K 7/08

(52) U.S. Cl. CPC H02K 1/32; H02K 5/203; H02K 7/083

(57) ABSTRACT

An assembly for cooling a rotor for an electric machine in a housing, wherein the rotor shaft is hollow and supports a coaxial drive shaft such that a radial gap is formed over the length of the rotor shaft between the inner diameter of the rotor shaft and the outer diameter of the drive shaft, wherein a first end of the rotor shaft has a dedicated stationary oil injection sleeve connected to an oil supply in the housing with which oil is injected axially into the radial gap where it is transported toward the second end of the rotor shaft. A vehicle that is or can be powered electrically, which has such an assembly, is also disclosed.

The present invention relates to an assembly for cooling a rotor for an electric machine in a housing, in which the shaft supporting the rotor is hollow and contains a coaxial drive shaft that rotates therein, with a radial gap formed between the inner diameter of the rotor shaft and the outer diameter of the drive shaft over the length of the rotor shaft. The invention also relates to a vehicle that is or can be powered electrically, which contains such an assembly.

EP 1 914 452 A2 discloses the use of a rotary union for conveying coolant in the form of oil from an oil supply in a housing into a radial gap between a stationary component of the housing and at least one rotating component.

With this type of rotary union, the oil is pumped from the housing into a radial gap. Numerous seals and a high operating pressure in the oil supply are needed to overcome the centrifugal force of the rotating component acting against this. This is accompanied by the disadvantage that the rotary union is structurally complicated and expensive.

The fundamental object of the present invention is to propose an assembly such as that described above in which the oil is supplied in a structurally simple and inexpensive manner.

This problem is solved by the features of claim 1. Advantageous and claimed embodiments can be derived from the dependent claims, the description, and the drawings.

An assembly for cooling a rotor for an electric machine in a housing is therefore proposed, in which the rotating shaft supporting the rotor is hollow and supported in the housing, and a rotating drive shaft is supported in the hollow shaft, such that a radial gap is formed over the entire length of the rotor shaft between the inner diameter of the rotor shaft and the outer diameter of the drive shaft. To be able to convey oil from the housing into the radial gap inside the rotor shaft in a structurally simple and inexpensive manner, it is proposed that a first end of the rotor shaft has a dedicated oil injection sleeve, or similar element, connected to the oil supply in the housing, which is attached to the housing in a stationary manner for injecting oil into the radial gap such that the oil is conveyed toward the other end of the rotor shaft.

This results in injection of coolant into the rotor shaft in electric machines without contact thereto, without the use of a complex rotary union. This allows oil to be injected into a hollow shaft rotating at a higher rate without generating frictional losses. Moreover, the operating pressure in the oil supply can be advantageously low.

A particularly simple structural design is obtained with the proposed assembly in that the oil injection sleeve has numerous axial grooves, or the like, on its outer circumference, the first ends of which can be supplied with oil from the oil supply in the housing, and are therefore dedicated thereto, and the second ends of which are dedicated to the radial gap at the inner diameter on the first end of the rotor shaft. The first end of each groove is therefore closed where it is supplied with oil, while the second end forms an open end of the injection sleeve, from which oil exits directly into the interior of the hollow shaft at the inner diameter of the rotor shaft.

By way of example, the grooves on the injection sleeve can have a semicircular cross section. These grooves can be formed particularly easily on the injection sleeve.

The shape and position of these axial grooves on the outer circumference of the injection sleeve ensure that the distance between it on the housing and the rotating component is as small as possible, and this distance is bridged by the grooves that basically form an injection nozzle, requiring only a relatively low operating pressure in the oil supply. This eliminates any frictional losses and high power consumption in the oil supply.

A particularly simple design for the oil supply to the injection sleeve in the proposed assembly provides that the inner surface of the housing has an annular channel along the outer circumference of the injection sleeve that is connected to the oil supply in the housing.

To convey the oil from the annular channel to the injection sleeve, the annular channel is dedicated to the first end of the groove such that the oil is conveyed from the annular channel into the grooves in the injection sleeve. The annular channel preferably has a semicircular, or similar, cross section.

Once the oil exits the injection grooves, it readily enters the interior of the rotor shaft. To prevent the oil from immediately exiting the first end of the rotor shaft, a ridge can be formed on the inner circumference of the first end thereof, to which the end of the injection sleeve is dedicated, thus reducing the inner diameter of the rotor shaft. This reduction of an axial section of the inner diameter of the rotor shaft causes the oil to be conveyed through the shaft.

The first end of the rotor shaft can have gear teeth in the assembly proposed by the present invention, which are located between an electric machine bearing and a transmission bearing. With this embodiment, the oil injection sleeve is pressed into a bearing plate on the transmission bearing, in which the bearing plate forms the stationary component on the housing that accommodates the injection sleeve.

The invention also relates to a vehicle that is or can be powered electrically, which has such an assembly.

The present invention shall be explained in greater detail below in reference to the drawings.

Therein:

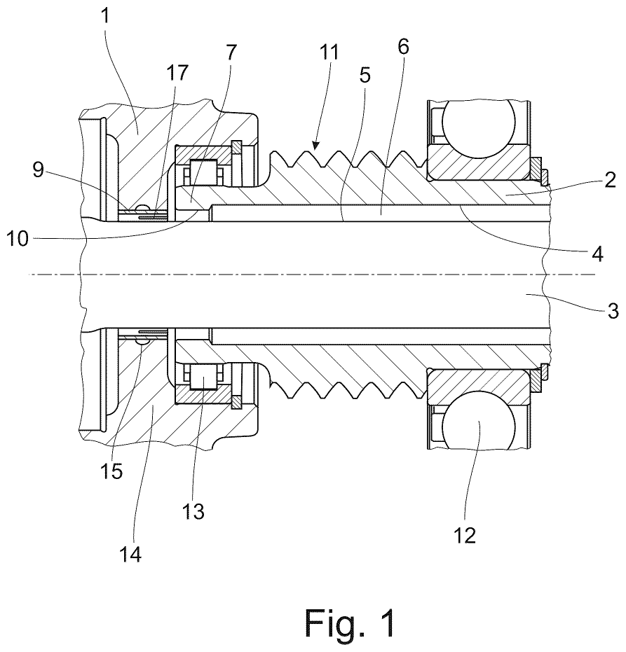

FIG. 1 shows a schematic cutaway partial view of an assembly for cooling a rotor for an electric machine in a housing;

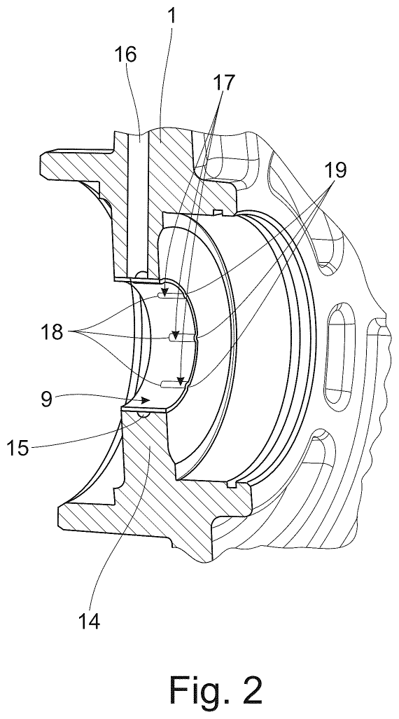

FIG. 2 shows a schematic three dimensional partial view of an oil injection sleeve in a housing for injecting oil axially into a rotor shaft;

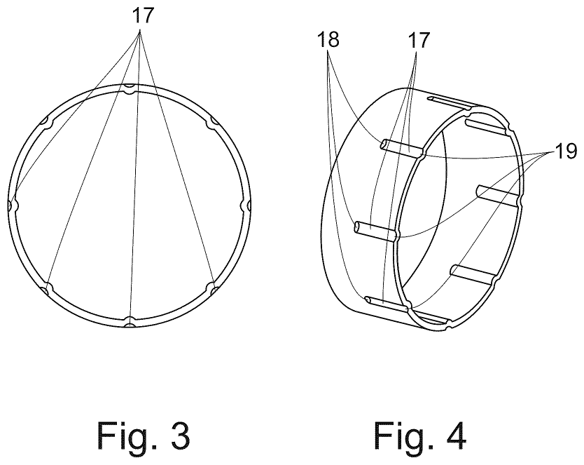

FIG. 3 shows the injection sleeve from the end;

FIG. 4 shows the injection sleeve in a three dimensional perspective; and

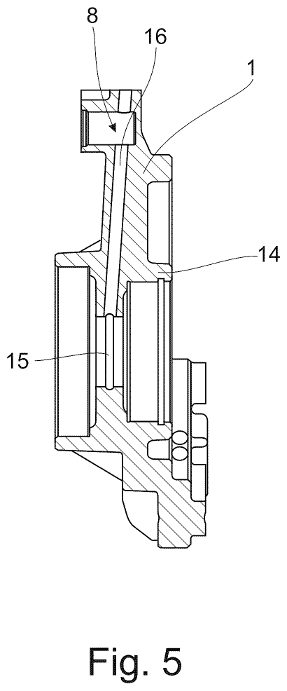

FIG. 5 shows a schematic cutaway partial view of an annular channel in the housing for supplying oil to the injection sleeve.

FIGS. 1 to 5 show different views of an assembly for cooling a rotor for an electric machine in a housing 1, in which the rotor shaft 2 is hollow and supports a rotating coaxial drive shaft 3 such that a radial gap 6 is formed over the length of the rotor shaft 2 between the inner diameter 4 of the rotor shaft 2 and the outer diameter 5 of the drive shaft 3. This assembly can form a drive train for an electric or hybrid vehicle, in which the electric machine forms the drive for the vehicle.

To obtain a structurally simple and inexpensive oil supply for the interior of the hollow rotor shaft 2, a first end 7 of the rotor shaft 2 has a dedicated stationary oil injection sleeve 9 connected to an oil supply 8 in the housing with which oil is injected axially into the radial gap 6 where it is then transported to the second end of the rotor shaft 2, not shown in the drawings.

The oil is therefore supplied by injecting it into the first, open end of the rotor shaft 2, instead of using the conventional rotary union. The oil is therefore conveyed into a rotating shaft without contact, and thus optimized with respect to power losses.

As FIG. 1 shows in particular, the oil injection sleeve 9 is basically a wide ring placed at the first end 7 of the rotor shaft 2. The first end 7 of the rotor shaft 2 in this embodiment has gear teeth 11 with which a drive torque from the electric machine, not shown, is transferred to a transmission. The gear teeth 11 are placed on the rotor shaft 2 between a bearing 12 for the electric machine and a bearing 13 for the transmission. The injection sleeve 9 is pressed into a transmission bearing plate 14 for the transmission bearing 13. The housing component, or bearing plate 14, into which the injection sleeve 9 is pressed, has a circumferential annular channel 15 with a semicircular cross section running over the outer circumference of the injection sleeve 9. This annular channel 15 is supplied with oil by the oil supply 8 in the housing through a bore 16.

There are numerous axial grooves 17 on the outer circumference of the injection sleeve 9 to which the annular channel 15 is dedicated, such that these grooves 17 are supplied with oil by the annular channel 15. The annular channel 15 is dedicated to the closed first ends 18 of the grooves 17 for this, and the open second ends 19 of the grooves 17 are dedicated to the end of the injection sleeve 9 and therefore the first axial end 7 of the rotor shaft 2. The open ends 19 of the grooves 17 therefore form injection nozzles with which the oil is injected into the rotor shaft 2, or the radial gap 6, such that the rotor shaft 2 is supplied with oil and thus cooled when in use.

Because the oil is no longer pressurized as soon as it enters the rotor shaft 2, a ridge 10 is formed in the first end 7 of the rotor shaft 2 to prevent the oil from immediately exiting at this end. The ridge 10 therefore reduces the inner diameter 4 of the rotor shaft 2 at this point. The rotation of the rotor shaft 2 distributes the oil on the inner diameter 4 of the rotor shaft 2, which is then transported toward the second end of the rotor shaft 2. The oil thus passes through the part of the rotor shaft 2 that heats up when in use, therefore cooling it.

### REFERENCE SYMBOLS

1 housing
2 rotor shaft
3 drive shaft
4 inner diameter of the rotor shaft
5 outer diameter of the drive shaft
6 radial gap between the rotor shaft and drive shaft
7 first end of the rotor shaft
8 oil supply in the housing
9 oil injection sleeve
10 ridge
11 gear teeth
12 electric machine bearing
13 transmission bearing
14 transmission housing bearing plate
15 annular channel
16 bore through the housing
17 groove
18 closed first end of the groove
19 open second end of the groove

1. An assembly for cooling a rotor for an electric machine in a housing,
wherein a rotor shaft is hollow and supports a coaxial drive shaft such that a radial gap is formed over a length of the rotor shaft between an inner diameter of the rotor shaft and an outer diameter of the drive shaft,
wherein a first end of the rotor shaft has a dedicated stationary oil injection sleeve connected to an oil supply in the housing which is configured to inject oil axially into the radial gap, wherein the oil is transported toward a second end of the rotor shaft.

2. The assembly according to claim 1,
wherein the injection sleeve comprises a plurality of axial grooves along its outer circumference,
wherein first ends of the plurality of axial grooves are configured to be supplied with oil from the oil supply in the housing, and
wherein a second end of each axial groove is dedicated to the radial gap in the inner diameter at the first end of the rotor shaft.

3. The assembly according to claim 2, wherein the plurality of axial grooves have a semicircular cross section.

4. The assembly according to claim 1, wherein an inner surface of the housing comprises an annular channel along an outer circumference of the injection sleeve that is connected to the oil supply in the housing.

5. The assembly according to claim 4, wherein the annular channel is dedicated to closed ends of each of a plurality of axial grooves such that the oil can be conveyed from the annular channel into the axial grooves.

6. The assembly according to claim 4, wherein the annular channel has a semicircular cross section.

7. The assembly according to claim 1, wherein the first end of the rotor shaft has a ridge that reduces the inner diameter of the rotor shaft.

8. The assembly according to claim 1, wherein the first end of the rotor shaft has gear teeth between an electric machine bearing and a transmission bearing.

9. The assembly according to claim 8, wherein the injection sleeve is pressed into a housing bearing plate in the transmission bearing.

10. An electric or hybrid vehicle comprising:
the assembly according to claim 1,
wherein the assembly forms at least a portion of a drive train of the electric or hybrid vehicle, and
wherein an electric machine forms a drive for the vehicle.

11. The assembly according to claim 2, wherein an inner surface of the housing comprises an annular channel along an outer circumference of the injection sleeve that is connected to the oil supply in the housing.

12. The assembly according to claim 11, wherein the annular channel is dedicated to closed ends of each of the plurality of axial grooves such that the oil can be conveyed from the annular channel into the axial grooves.

13. The assembly according to claim 5, wherein the annular channel has a semicircular cross section.

14. The assembly according to claim 2, wherein the first end of the rotor shaft has a ridge that reduces the inner diameter of the rotor shaft.

15. The assembly according to claim 4, wherein the first end of the rotor shaft has a ridge that reduces the inner diameter of the rotor shaft.

16. The assembly according to claim 5, wherein the first end of the rotor shaft has a ridge that reduces the inner diameter of the rotor shaft.

17. The assembly according to claim 6, wherein the first end of the rotor shaft has a ridge that reduces the inner diameter of the rotor shaft.

18. The assembly according to claim 2, wherein the first end of the rotor shaft has gear teeth between an electric machine bearing and a transmission bearing.

19. The assembly according to claim 4, wherein the first end of the rotor shaft has gear teeth between an electric machine bearing and a transmission bearing.

20. The assembly according to claim 5, wherein the first end of the rotor shaft has gear teeth between an electric machine bearing and a transmission bearing.
